(19) United States
(12) Patent Application Publication
(10) Pub. No.: US 2009/0272543 A1
(43) Pub. Date: Nov. 5, 2009

(54) Tubular Running Devices and Methods

(75) Inventors: Vernon J. Bouligny, New Iberia, LA (US); Donald E. Mosing, Lafayette, LA (US); Jeremy R. Angelle, Lafayette, LA (US)

Correspondence Address: Winstead PC (FCC-FKI);Henry L. Ehrlich, P.O. Box 50784, Dallas, TX, 75201, US

(73) Assignee: Frank's Casting Crew and Rental Tools, Inc., Lafayette, LA (US)

(21) Appl. No.: 12/435,999

(22) Filed: May 5, 2009

Related U.S. Application Data
(60) Provisional application No. 61/050,578, filed on May 5, 2008.

(51) Int. Cl. E21B 19/10; E21B 19/07; B66C 1/42; E21B 19/16

(52) U.S. Cl. 166/381; 414/800; 294/102.2; 166/77.1; 166/77.51

(57) ABSTRACT

One example of an apparatus for gripping and rotating a tubular includes a mandrel having a longitudinal axis; a first slip disposed on the mandrel; and a second slip disposed on the mandrel axially spaced apart from the first slip, the first slip and second slip operationally connected to move in unison axially; wherein when the first slip and the second slip are moved axially from a first point toward a second point the first and second slips extend radially into gripping contact with the tubular and wherein rotation of the mandrel further urges the second slip radially away from the mandrel.

### RELATED APPLICATIONS

This application claims the benefit of U.S. Provisional Patent Application No. 61/050,578 filed May 5, 2008.

### TECHNICAL FIELD

The present invention relates in general to wellbore operations and more particularly to the use of tubulars, such as casing, to drill wellbores, complete wellbores and to conduct other wellbore operations.

### BACKGROUND

In the drilling and completion of wells it is necessary to run tubular strings into and out of the wellbore. The tubular strings are formed of various pipe types, weights, and diameters depending on the operation performed. In addition, to running tubular strings into and out of the wellbore it is often necessary to rotate the tubular string. For example, it is often desired to drill the wellbore using casing or to rotate the casing for a cementing operation. It is therefore a benefit to provide devices and methods facilitating one or more of gripping tubulars, axially moving the tubulars, and rotating the tubular.

### SUMMARY

One embodiment of a tubular gripping apparatus includes a mandrel having a longitudinal axis, and a slip having opposing sidewalls disposed on the mandrel, wherein the opposing sidewalls interact with the mandrel to move the slip radially away from the mandrel when the slip is moved axially along the mandrel.

Another embodiment of an apparatus for gripping and rotating a tubular includes a mandrel having a longitudinal axis; a first slip disposed on the mandrel; and a second slip disposed on the mandrel axially spaced apart from the first slip, the first slip and second slip operationally connected to move in unison axially; wherein when the first slip and the second slip are moved axially from a first point toward a second point the first and second slips extend radially into gripping contact with the tubular and wherein rotation of the mandrel further urges the second slip radially away from the mandrel.

An embodiment of an apparatus for gripping and rotating a tubular includes a mandrel having a longitudinal axis; a floor provided by the mandrel, the floor having an angled taper relative to the longitudinal axis and providing a rotary cam surface; and a slip disposed on the floor, wherein axially movement of the slip urges the slip radially from the mandrel and wherein rotation of the mandrel urges the slip radially when the slip is in contact with a tubular.

An embodiment of a method for gripping a tubular includes the steps of disposing a slip on a mandrel, the slip having opposing sidewalls; inserting the slip into the tubular; and moving the opposing sidewalls of the slip axially along the mandrel extending the slip radially into gripping contact with the tubular.

Another embodiment of a method for gripping a tubular includes the steps of providing a slip having opposing sidewalls diverging away from one another as they extend from the bottom surface to the outer surface; disposing the opposing sidewalls of the slip on opposing ramps separated by a floor of a mandrel, the opposing lateral ramps converging toward one another as they extend axially from a first point to a second point; inserting the slip into the tubular; and moving the slip axially from the first point toward the second point and radially into gripping engagement with the tubular.

An embodiment of a method for gripping and rotating a tubular includes the steps of disposing a first slip on a mandrel; disposing a second slip on the mandrel axially apart from the first slip; inserting the first and the second slips into the tubular; axially moving the first and the second slips in unison urging the first slip and the second slip radially into contact with the tubular; and applying rotation from the mandrel to the tubular via the first slip and the second slip, wherein rotation of the mandrel urges the second slip radially from the mandrel.

Another embodiment of a method for gripping a tubular includes the steps of disposing a slip on a mandrel; inserting the slip into the tubular; moving the slip axially and radially relative to the mandrel and into contact with the tubular; and rotating the mandrel urging the slip further radially into engagement with the tubular.

The foregoing has outlined some of the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an elevation view of an embodiment of a tubular running tool of the invention;

FIG. 2 is an elevation view of an embodiment of the tubular running tool of the invention disposed from a top drive;

FIG. 3 is a perspective view of an embodiment of the tubular gripping portion of the tubular running tool with the slips retracted;

FIG. 4 is a perspective view of an embodiment of the tubular gripping apparatus portion of the tubular running tool with the slips extended;

FIG. 5 is a perspective view an embodiment of the tubular gripping apparatus portion with the slips removed;

FIG. 5A is an axial view along the line I-I of FIG. 5;

FIG. 6 is an elevation view of a bottom surface of an embodiment of a slip shown in isolation;

FIG. 7 is a perspective view another embodiment of the tubular gripping apparatus portion with the slips removed;

FIG. 7A is a sectional view along the line II-II of FIG. 7;

FIG. 7B is a sectional view along the line III-III of FIG. 7;

FIG. 8 is an elevation view of another embodiment of a slip and tubular gripping apparatus;

FIG. 8A is a sectional view along the line IV-IV of FIG. 8; and

FIG. 9 is a view of the assembly of FIG. 8 illustrating the slips in the extended position.

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; “top” and “bottom”; and other like terms indicating relative positions to a given point or element are utilized to more clearly describe some elements. Commonly, these terms relate to a reference point as the surface from which drilling operations are initiated as being the top point and the total depth of the well being the lowest point. The terms “pipe,” “tubular,” “tubular member,” “casing,” “liner,” tubing,” “drill pipe,” “drill string” and other like terms can be used interchangeably. The terms may be used in combination with “joint” to mean a single unitary length; a “stand” to mean one or more, and typically two or three, interconnected joints; or a “string” meaning two or more interconnected joints.

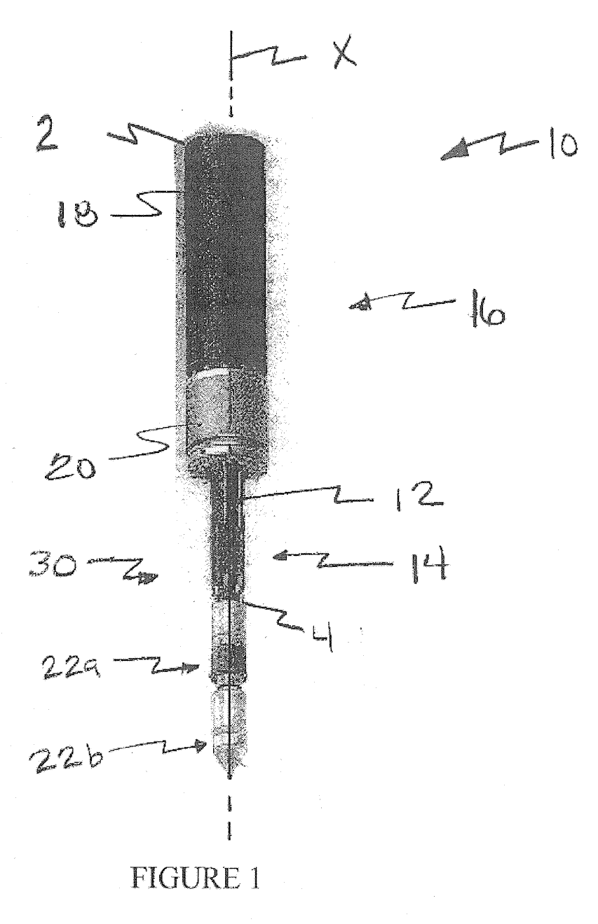

FIG. 1 is an elevation view of an embodiment of a tubular running tool generally denoted by the numeral 10. Tubular running tool 10 includes a mandrel 12, slips 14, and main body 16. Tubular running tool 10 can be utilized to grip pipe and to move pipe axially and or rotationally.

Main body 16 can include, without limitation, compensators, rotational driving mechanisms, and axial driving mechanisms. In the embodiment illustrated in FIG. 1, tool 10 includes a thread compensator 18 and an actuator 20, e.g., an axial driving mechanism. Actuator 20 will be described herein as a fluidic (e.g., pneumatic or hydraulic) mechanism for moving slips 14 axially along the tools longitudinal axis indicated by “X.” For purposes of description, tool 10 has a top end 2 and a bottom end 4. Bottom end 4 is illustrated in the various Figures for purposes of describing various element and relative orientation of elements to one another and is therefore not limited to a specific location. Bottom end 4 is illustrated in FIG. 1 proximate to the bottom end of slips 14.

Tool 10 may include additional devices 22 such as and without limitation to the illustrated packer 22a and stabbing guide 22b. Examples of some additional devices 22 that are not illustrated can include without limitation valves, fluid circulating devices, cementing tools, and wiper plugs.

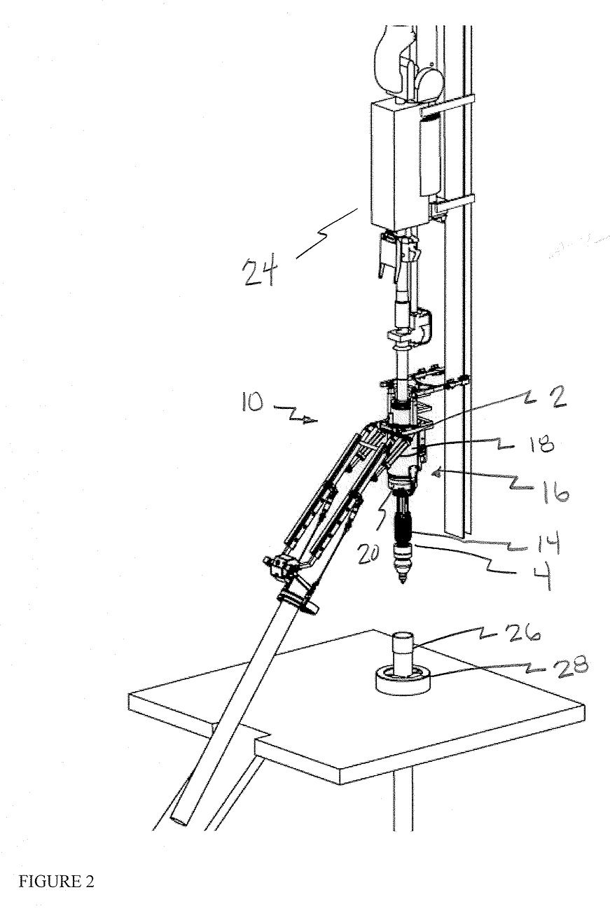

Tool 10 can be used with top drive and rotary systems. Tubular running tool 10 is illustrated in FIG. 2 disposed from a top drive 24 and suspended over a pipe 26. Pipe 26 is illustrated as being held by a spider 28. In FIG. 2 pipe 26 is the top end of a pipe string that is disposed in the wellbore. In the illustrated embodiment, pipe 26 is casing and can include a drilling bit or like device for drilling with the casing.

In the illustrated embodiment, rotational movement of portions of tool 10, such as slips 14, are provided by top drive 24 for the purpose of rotating casing 26. Other devices may be utilized to provide rotation to casing 26 via tool 10 or directly to casing 26. Some examples include without limitation an external rotation device such as power tongs, rotary spiders, a driving mechanism included in body 16, or another driving mechanism that may be for example disposed from top drive 24.

Slips 14 are illustrated in FIG. 2 in a retracted position in preparation for stabbing into casing 26. After insertion into casing 26, slips 14 can be actuated to engage the inside surface of casing 26. Tubular running tool 10 can grip casing 26 via slips 14, carry the weight of casing 26, be utilized for lifting and lowering casing 26, and or providing rotational movement to casing 26.

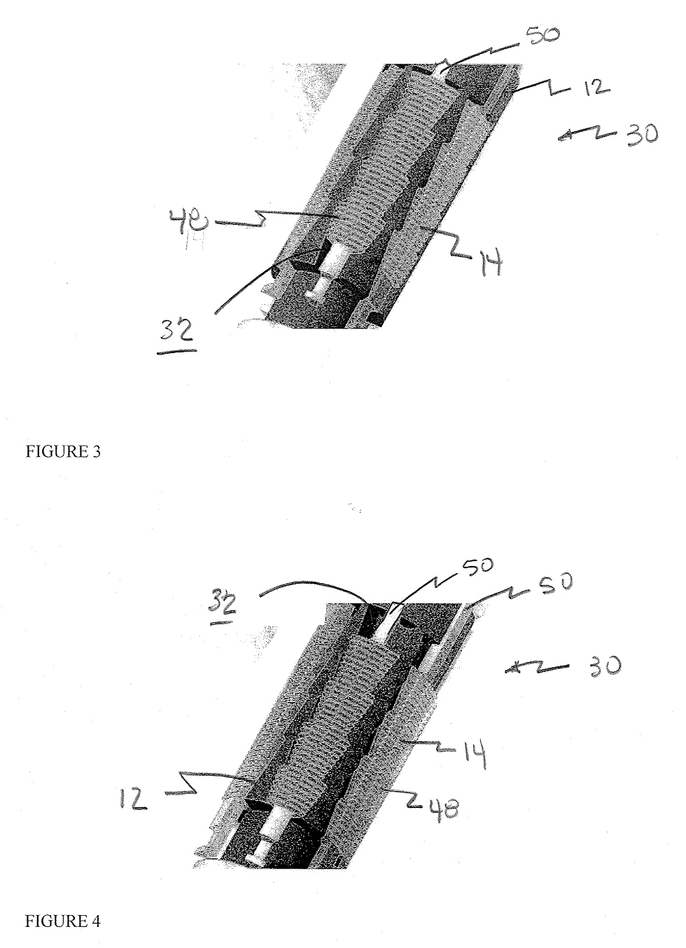

Refer now to FIGS. 3 and 4 wherein slips 14 are illustrated respectively in a retracted position and an extended position for engaging a tubular. Slips 14 are disposed on mandrel 12 such that axial movement of slips 14 along mandrel 12 moves slips 14 radially between the retracted and the engaged position. The portion of mandrel 12 carrying the slips is generally referred to herein as the tubular gripping apparatus 30.

In the illustrated embodiments, slips 14 are operational disposed within troughs 32 that are formed by mandrel 12. Slips 14 have an outer surface 48 for gripping the tubular and may include an upper arm or shaft 50 that can be operationally connected to actuator 20 (FIG. 1). Outer surface 48 for gripping may be unitary to slip 14 or attached to slip 14. Illustrated slips 14 are movable axially downward from the retracted position of FIG. 1 to the extended position of FIG. 4. As illustrated slip 14 is axially moved, the sidewalls of slip 14 and the lateral ramp portions of trough 32 motivate slip 14 radially outward from mandrel 12.

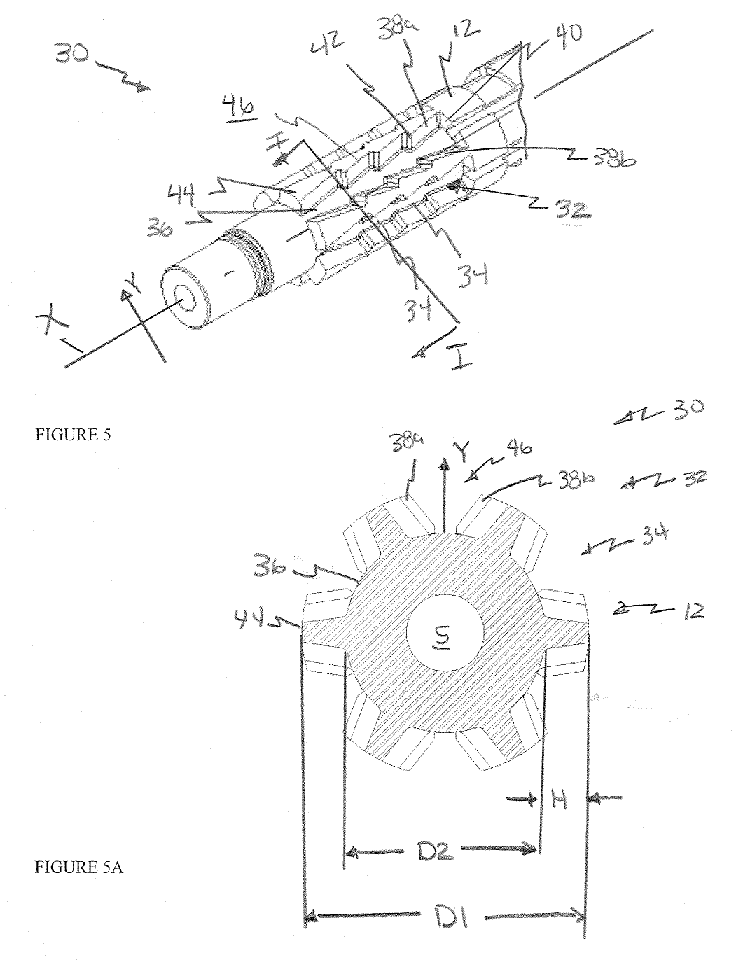

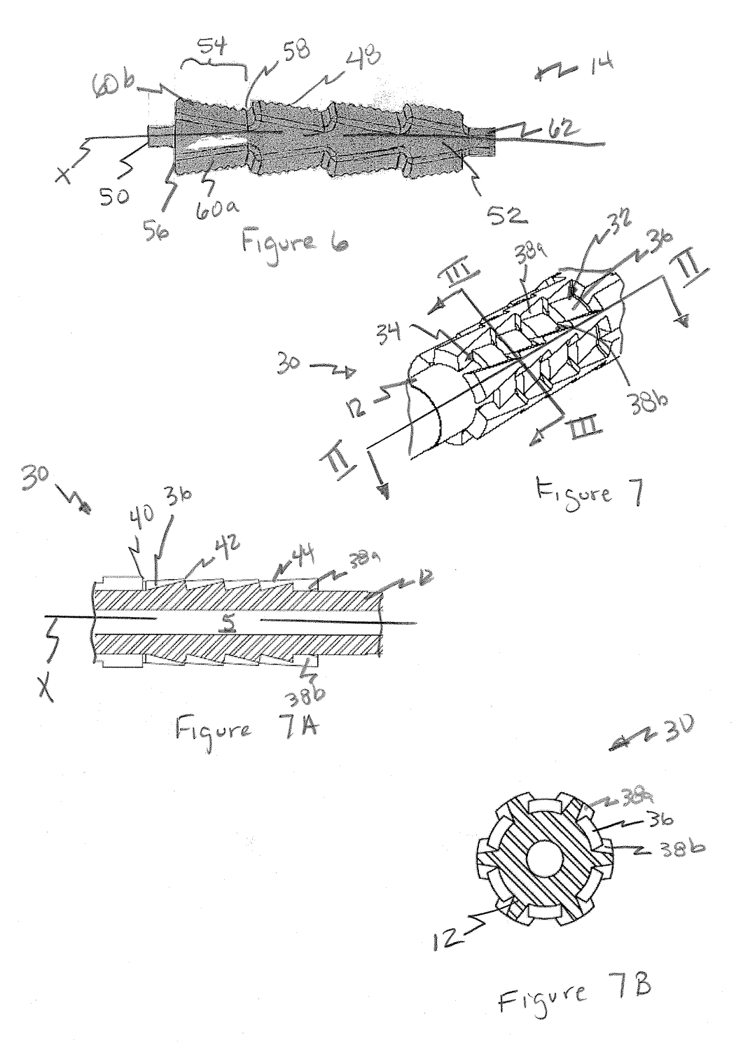

Refer now to FIG. 5 wherein an embodiment of tubular gripping apparatus 30 is illustrated with slips 14 removed. Troughs 32 are formed by mandrel 12, to extend generally from what is denoted as outer surface 44 to a floor 36. In the illustrated example, each trough 32 extends axially along mandrel 12 and includes a plurality of interconnected traps 34. Traps 34 are adapted to operationally dispose slip pods 54 (FIG. 6). It is noted that in some embodiments that trough 32 may comprise a singe trap 34.

Each trap 34 is defined by floor 36 that separates opposing lateral ramps 38a, 38b, a trap first end 40, and a trap second end 42. In this illustration, the first end corresponds to the top of the apparatus and the second end corresponds to the bottom of the apparatus however, in some embodiments the orientations of the various elements differ. Opposing lateral ramps 38a, 38b are the sidewalls of trough 32 and traps 34. Opposing lateral ramps 38a, 38b converge toward one another as they extend axially from trap top end 40 to trap bottom end 42 to form a substantially arrow head shaped chamber tapering from a larger diameter at trop top end 40 to a smaller diameter at trap bottom end 42.

In the illustrated embodiments, lateral ramps 38a, 38b extend radially outward from floor 36 to outer surface 44 at a non-perpendicular angle to longitudinal axis X. Opposing lateral ramps 38a, 38b diverge away from one another as they extend radially outward from floor 36. Thus, floor 36 has a smaller area or footprint than the area at the opening 46 of trough 32 at outside diameter D1 (FIG. 5A).

Refer now to FIG. 5A wherein a cross-section view of gripping apparatus 30 along the line I-I of FIG. 5 is provided. Mandrel 12 includes a longitudinal bore 5. In this embodiment, mandrel 12 has an outside diameter D1 corresponding to outer surface 44 and an inner diameter D2 that corresponds to a circumferential portion of mandrel 12 that forms at least a portion of floor 36. In the embodiment illustrated in FIGS. 5 and 5A, floor 36 extends substantially parallel to longitudinal axis X and does not provide a tapered ramp surface. Therefore diameter D2 corresponds across the cross-section of floor 36. In some embodiments, for example as illustrated in FIG. 7, floor 36 it tapered and therefore D2 changes axially along floor 36. Trough 32 and trap 34 have a height “H,” that corresponds in this embodiment to the difference between D1 and D2.

In some embodiments, inner diameter D2 may be designated to correspond to a selected base point. For example, in the embodiment of FIG. 7, floor 36 is not parallel to longitudinal axis but forms a tapered ramp. Thus, the inner diameter of mandrel 12 may be identified as the inner diameter at trap top end 40 of trap 34 or another point. In the illustrated examples of FIGS. 5 and 7, inner diameter D2 is substantially circular and concentric with outer diameter D1.

A radial axis, identified by “Y,” extends perpendicular to axis X (FIGS. 1 and 5) and is illustrated in FIGS. 5 and 5A to illustrate the radial configuration of trough 32. Opposing lateral ramps 38a, 38b extend from floor 36 and terminate at outer surface 44 defining an outer opening 46 therebetween. As opposing lateral ramps 38a, 38b extend radially out from floor 36 to outer surface 44 they angle away, or diverge, from each other and radial axis Y.

Refer now to FIG. 6, wherein a bottom view of an embodiment of slip 14 is illustrated. Bottom surface 52 is opposite from outer gripping surface 48 shown in FIGS. 3 and 4. In the illustrated embodiment, slip 14 includes multiple, axially interconnected slip pods 54. Each pod 54 can be shaped to substantially match the configuration of a respective trap so as to be urged radially relative to mandrel 12 as it moves axially along the trap. The illustrated slip 14 corresponds to the embodiments of mandrel 12 illustrated in FIGS. 5 and 7.

In the illustrated examples, each pod 54 may be arrow head shaped extending from the larger upper end 56 to the narrower bottom end 58. Opposing longitudinal sidewalls 60a, 60b diverge away from each other as they extend from bottom surface 52 to outer surface 48 to form slip surfaces corresponding to opposing lateral ramps 38a, 38b (FIGS. 5 and 7). Opposing lateral ramps 38a, 38b and sidewalls 60a, 60b interact to move slips 14 radially as they move axially along mandrel 12. Illustrated outer surface 48 has a larger footprint than bottom surface 52. Slip 14 may include a bottom shaft 62. In the illustrated embodiment, bottom surface 52 is oriented substantially parallel to longitudinal axis X when disposed on mandrel 12 and does not form an axially tapered surface.

Refer now to FIG. 7 wherein another embodiment of a mandrel 12 with troughs 32 having at least one trap 34 is illustrated in isolation. Refer also to FIGS. 7A and 7B providing a sectional views along the line II-II and line III-III of FIG. 7 respectively. As described with reference to FIGS. 5 and 5A, trap 34 is defined by a floor 36 separating opposing lateral ramps 38a, 38b. In this embodiment, floor 36 does not extend substantially parallel to longitudinal axis X. Instead, floor 36 is tapered radially outward from longitudinal axis X as it extends axially from trap top end 40 to trap bottom end 42. The axially tapered trap floor 36 in this embodiment provides a slip surface in addition to the slip surface providing by opposing lateral ramps 38a, 38b for motivating the slips radially.

An example of a method of operation of tool 10 is now described with reference to FIGS. 1 through 7. Illustrated tool 10 is disposed from a top drive 24. With slips 14 in the retracted position, top drive 24 may move tool 10 axially downward, positioning slips 14 adjacent to casing 26, wherein the slips are positioned inside of casing 26 for a internal gripping tool 10 and outside of casing 26 for an external gripping tool (not illustrated). Axial actuator 20 can then be activated, driving shaft 50 and slip 14 axially downward. Although illustrated with a driving shaft 50 and actuator 20, any means known in the art may be used to dispose slip 14. As slip 14 moves downward, opposing lateral ramps 38a, 38b and opposing sidewalls 60a, 60b interact urging slips 14 radially into gripping engagement of casing 26. In some embodiments, such as illustrated in FIG. 5, there may be a gap between floor 36 and bottom surface 52 of slip 14 when in the extended position. In the embodiment of FIG. 5, floor 36 may not urge slip 14 radially. In some embodiments, such as that of FIG. 7, floor 36 may remain substantially in contact with bottom surface 52 and provide a ramp surface interacting with bottom surface 52 to further urge the radial movement of slip 14. Rotational movement may then be applied to casing 26 via slips 14. Axial movement of casing 26 may also be facilitated through the gripping engagement of slips 14.

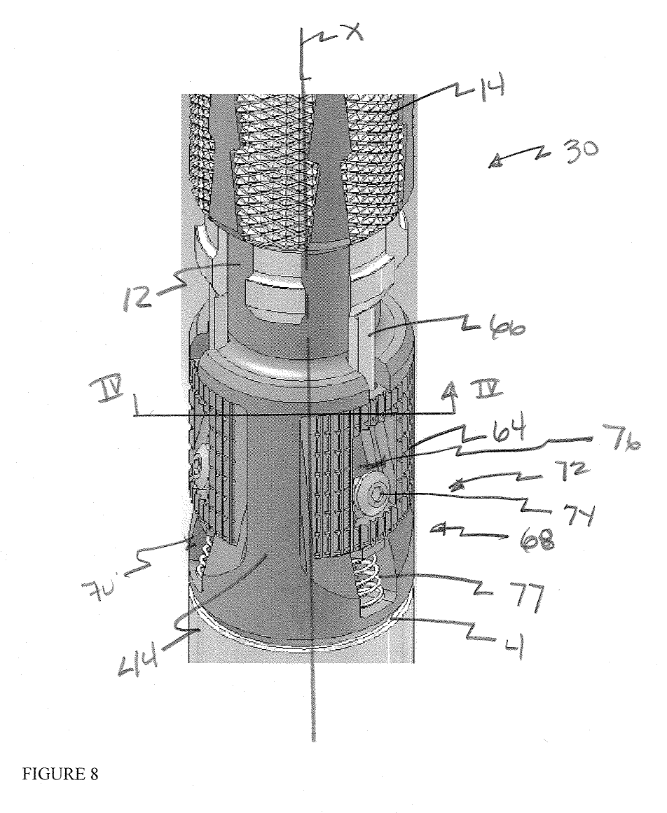

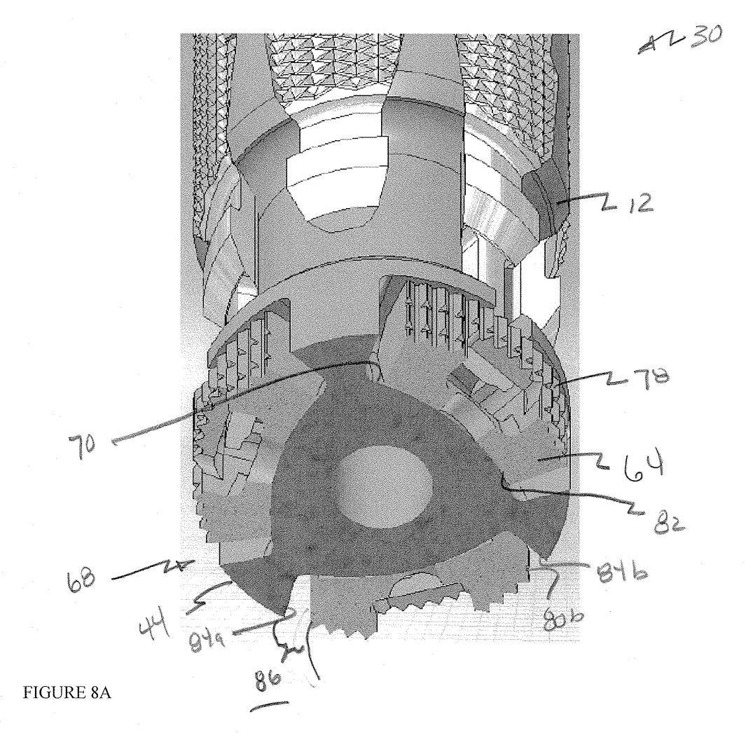

Refer now to FIG. 8, wherein another embodiment of a slip, identified by the numeral 64, is illustrated with gripping apparatus 30. In the illustrated embodiment, gripping apparatus 30 includes slip 64 (e.g., a second slip, torque slip) in combination with slips 14. In some embodiments, gripping apparatus 30 may comprise only slips 64. It is specifically noted that slips 14 may comprise embodiments that are not identified or disclosed herein and may be slips and/or gripping apparatus that are known in the art.

For purposes of description and to avoid confusion between slips 14 and slips 64, slips 64 may be referred to from time to time herein as torque slips or camming slips. These designations are not intended to be limiting or to functionally define slips 64 relative to other slips that may be utilized. For example, slips 64 and slips 14 as disclosed above can both be utilized to transfer torque to the engaged and gripped tubular. Additionally, for purposes of describing some embodiments, first and second may be utilized to describe slips 14 and 64.

In the embodiments illustrated herein, torque slip 64 is illustrated utilized in combination with a slip 14, referred to herein for purposes of description as first slip 14. Referring to FIG. 8, torque slip 64 is disposed on mandrel 12 and spaced axially from slip 14. In the illustrated embodiments, each torque slip 64 corresponds to one of the first slips 14 however; each first slip 14 may not correspond to a torque slip 64 or a first slip 14 may have multiple torque slips 64 (not illustrated).

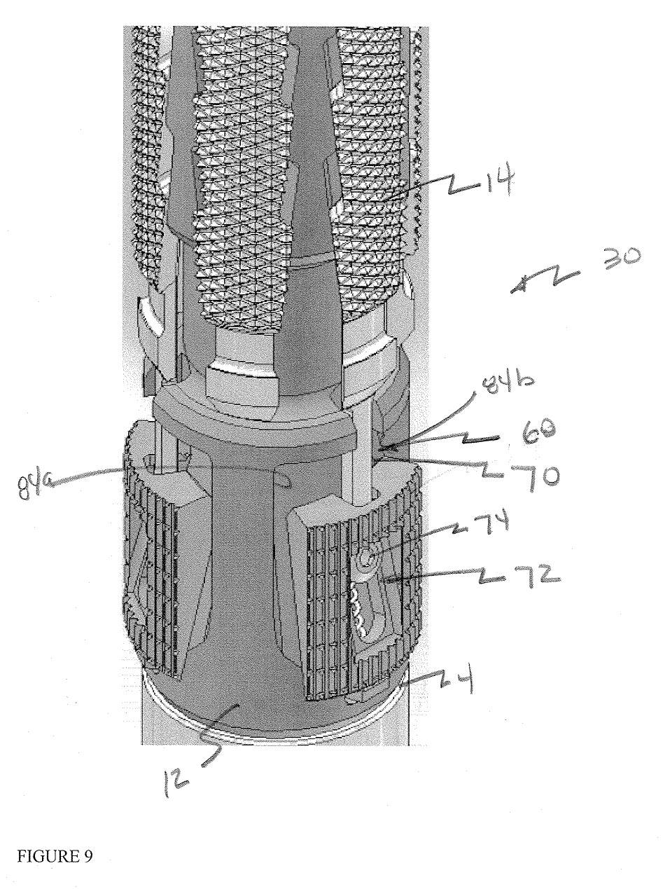

In this embodiment, torque slip 64 is functionally connected to slip 14 such that torque slip 64 is moved axially (e.g., in unison) with movement of first slip 14, for example, by a shaft 66. Torque slip 64 is shown in FIG. 8 in the up position corresponding to the retracted position of slips 14. Torque slip 64 is shown in FIG. 9 in the extended position.

In the illustrated embodiment, slip 64 is disposed on mandrel 12 such that axial and rotational movement of mandrel 12 can move torque slip 64 radially relative to mandrel 12. Torque slip 64 is disposed on a floor surface 70 on mandrel 12. In the illustrated embodiment, surface 70 is recessed from outer surface 44 of mandrel 12 and is the bottom surface of a trap 68. Floor 70 may be tapered radially outward from the mandrel's longitudinal axis as it extends downward. In the illustrated embodiment floor 70 provides a straight taper.

In some embodiments, torque slip 64 is functionally disposed on floor 70 of mandrel 12 to facilitate axial movement in unison with slip 14; and radial movement of torque slip 64, in unison with radial movement of slip 14 and independent of movement of slip 14. An example of a functional and operational connection 72 for disposing torque slip 64 on mandrel 12 is illustrated in FIGS. 8 and 9. The illustrated connection includes a post 74 extending radially outward from a floor 70 provided on mandrel 12. Post 74 extends through a window 76 formed through torque slip 64. A biasing mechanism 77, such as a spring, may be provided to urge torque slip 64 axially along floor 70 toward the retracted position.

Refer now to FIG. 8A, wherein a cross-sectional view along the line IV-IV of FIG. 8 illustrates slip 64 portion of tubular gripping apparatus 30. It is again noted that gripping apparatus 30, although not illustrated herein, may comprise only torques slip 64 and not include an additional slip.

Torque slip 64 includes an outer surface 78, opposing sidewalls 80a, 80b, and a bottom surface 82. Torque slip 64 is disposed on a portion of mandrel 12 designated by floor 70. In the illustrated embodiments, floor 70 separates opposing sidewalls 84a, 84b to form a recess or trap 68. Trap 68 may be sized in some embodiments to provide a gap 86 between the sidewalls 84a, 84b of trap 68 and the sidewalls 80a, 80b of slip 64. In the illustrated embodiments, gap 86 can accommodate the relative lateral movement of slip 64 as it is urged radially outward from mandrel 12. In the illustrated embodiment, sidewalls 80a, 80b converge toward one another as they extend radially out from floor 70 to outer surface 44.

In the illustrated embodiments, floor 70 is configured to provide a camming surface corresponding with bottom surface 82 of slip 64. In the illustrated embodiment, floors 70 transform mandrel 12 into to a triangular rotary configuration that can urge slips 64 radially outward when gripping casing 26 and mandrel 12 is rotated. With reference to FIGS. 5 and 7 it was identified that in some embodiments the inner diameter of mandrel 12 is substantially circular and concentrically positioned relative to the outer diameter. In the embodiments illustrated in FIGS. 8 and 9, the portion of mandrel 12 that defines floors 70 is not substantially circular.

An embodiment of a method of use of tool 10 is now described with reference to FIGS. 1 through 9. The following method is described with reference to an internal gripping embodiment of tool 10, however, it is noted that an external gripping embodiment of tool 10 would operate similarly. Tool 10 is provided having an actuator 20, first slip 14, and a torque slip 64. Tool 10 may include additional devices 22. Tool 10 is disposed from a top drive 24 and in this embodiment with torque slips 64 positioned axially below first slips 14. First slips 14 and torque slips 64 are positioned in the retracted position and inserted into casing 26 in the illustrated internally gripping embodiment. Driver 26 is actuated; axially moving slips 14 and slips 64 axially downward as depicted. As slips 14 move downward, opposing lateral ramps 38a, 38b urge slips 14 radially outward and into the extended position gripping the interior of casing 26. The weight of casing 10 can be carried by the gripping engagement of slips 14. Torque slips 64 are also moved axially downward with the axial movement of slips 14 to the extended position. Rotational movement may be applied to mandrel 12. In one embodiment, when rotation commences, outer surface of torque slip 64 is gripping casing 26 and mandrel 12 urges torque slip 64 radially outward from floor 70 and into further gripping engagement with casing 26. When it is desired to disengage connection from casing 26, drive 20 can be actuated to move slips 14 and 64 upward and toward the retracted position. Tool 10 may be used, without limitation, to form a wellbore, drill a wellbore, to make-up tubular strings, to break-out tubular strings, etc.

From the foregoing detailed description of specific embodiments of the invention, it should be apparent that device and methods for gripping tubulars (e.g., internally and/or externally) and for axially and/or rotationally moving the gripped tubular that are novel have been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. A method for gripping a tubular, the method comprising the steps of:
disposing a slip on a mandrel, the slip having opposing sidewalls;
disposing the slip adjacent to the tubular; and
moving the opposing sidewalls of the slip axially along the mandrel extending the slip radially into gripping contact with the tubular.

2. The method of claim 1, further including the step of applying rotation to the tubular via the slip.

3. The method of claim 1, wherein the slip has a bottom surface oriented toward the mandrel, an outer surface, and the opposing sidewalls of the slip diverge away from one another as they extend from the bottom surface to the outer surface.

4. The method of claim 3, wherein contact between the bottom surface and the mandrel does not urge radial movement of the slip.

5. The method of claim 3, further including the step of applying rotation to the tubular via the slip.

6. The method of claim 4, further including the step of applying rotation to the tubular via the slip.

7. The method of claim 1, wherein:
the mandrel provides opposing lateral ramps separated by a floor, the opposing lateral ramps converging toward one another as they extend axially from a first point to a second point; and
the opposing sidewalls of the slip disposed on the opposing lateral ramps.

8. The method of claim 7, further including the step of applying rotation to the tubular via the slip.

9. The method of claim 1, further including the step of disposing the mandrel from a top drive.

10. The method of claim 9, further including the step of applying rotation to the tubular via the slip.

11. The method of claim 10, wherein rotation is provided by the top drive.

12. A method for gripping a tubular, the method comprising the steps of:
providing a slip having a bottom surface, an outer surface and opposing sidewalls that diverge away from one another as they extend from the bottom surface to the outer surface;
disposing the opposing sidewalls of the slip on opposing lateral ramps separated by a floor of a mandrel, the opposing lateral ramps converging toward one another as they extend axially from a first point to a second point;
positioning the slip adjacent to the tubular; and
moving the slip axially from the first point toward the second point and radially into gripping engagement with the tubular.

13. The method of claim 12, further including the step of applying rotation to the tubular via the slip.

14. The method of claim 12, further including the step of disposing the mandrel from a top drive.

15. The method of claim 14, further including the step of applying rotation to the tubular via the slip.

16. The method of claim 15, wherein rotation is provided by the top drive.

17. The method of claim 12, further including the steps of:
disposing a torque slip on the mandrel axially spaced from the slip; and
moving the torque slip axially in unison with the axial movement of the slip.

18. The method of claim 17, further including the step of urging the torque slip radially away from the mandrel by rotating the mandrel.

19. The method of claim 18, wherein rotation of the mandrel does not urge the slip radially away from the mandrel.

20. A method for gripping and rotating a tubular, the method comprising the steps of:
disposing a first slip on a mandrel;
disposing a second slip on the mandrel axially apart from the first slip;
positioning the first and the second slips adjacent to the tubular;
axially moving the first and the second slips in unison urging the first slip and the second slip into contact with the tubular;
rotating the mandrel urging the second slip radially away from the mandrel; and
applying the rotation from the mandrel to the tubular via the first slip and the second slip.

21. The method of claim 20, wherein the second slip moves radially upon initiating rotation of the mandrel independent of movement of the first slip.

22. The method of claim 20, including the step of disposing the mandrel from a top drive.

23. The method of claim 22, wherein the step of rotating is performed by the top drive.

24. The method of claim 20, wherein:
the first slip comprises opposing sidewalls diverging away from one another as they extend from a bottom surface and an outer surface of the first slip;
the mandrel comprises opposing lateral ramps converging toward one another as they extend axially from a first point to a second point; and
comprising the step of disposing the opposing sidewalls of the first slip on the opposing lateral ramps.

25. The method of claim 24, wherein the second slip moves radially upon initiating rotation of the mandrel independent of movement of the first slip.

26. The method of claim 24, further comprising the step of disposing the mandrel from a top drive.

27. The method of claim 26, wherein the step of rotating is provided to the mandrel from the top drive.

28. A tubular gripping apparatus, the apparatus comprising:
a mandrel having a longitudinal axis; and
a slip having opposing sidewalls disposed on the mandrel wherein the opposing sidewalls interact with the mandrel to move the slip radially away from the mandrel when the slip is moved axially along the mandrel.

29. The apparatus of claim 28, wherein the opposing sidewalls diverge away from one another as they extend from a bottom surface to an outer surface.

30. The apparatus of claim 28, wherein:
the mandrel comprises opposing lateral ramps that converge toward one another as they extend from a first point to a second point; and
the opposing sidewalls of the slip are disposed on the opposing lateral ramps.

31. The apparatus of claim 30, wherein the opposing sidewalls of the slip diverge away from one another as they extend from a bottom surface to an outer surface.

32. The apparatus of claim 28, further including a rotational driving mechanism applying rotational movement to the slip.

33. The apparatus of claim 32, wherein the rotational driving mechanism is a top drive.

34. The apparatus of claim 28, further including a torque slip disposed on the mandrel, the torque slip operationally connected to the slip to move axially in unison with the slip and to move radially away from the mandrel upon rotation of the mandrel independent of movement of the slip.

35. The apparatus of claim 34, wherein:
the mandrel comprises opposing lateral ramps converging toward one another as they extend from a first point to a second point; and
the opposing sidewalls of the slip disposed on the opposing lateral ramps.

36. The apparatus of claim 35, wherein the opposing sidewalls slip diverge away from one another as they extend from a bottom surface to an outer surface.

37. The apparatus of claim 34, further including a rotational driving mechanism applying rotational movement to the slip.

38. The apparatus of claim 37, wherein the rotational driving mechanism is a top drive.

39. The apparatus of claim 34, wherein rotational movement of the mandrel urges the torque slip radially away from the longitudinal axis.

40. An apparatus for gripping and rotating a tubular, the apparatus comprising:
a mandrel having a longitudinal axis;
a first slip disposed on the mandrel; and
a second slip disposed on the mandrel axially spaced apart from the first slip, the first slip operationally connected with the second slip, wherein when the first slip and the second slip move axially from a first point toward a second point the first and second slips extend into gripping contact with the tubular and wherein rotation of the mandrel further urges the second slip radially away from the mandrel.

41. The apparatus of claim 40, wherein the mandrel is disposed from a top drive.

42. The apparatus of claim 41, wherein the mandrel applies rotational movement to the mandrel.

43. The apparatus of claim 40, wherein:
the first slip comprises opposing sidewalls that diverge away from one another as they extend from a bottom surface to an outer surface of the first slip; and
the opposing sidewalls interact with the mandrel to urge the first slip radially.

44. The apparatus of claim 43, wherein the mandrel comprises a first trap having opposing lateral ramps converging toward one another as they extend axially from the first point toward the second point, the opposing sidewalls disposed on the opposing lateral ramps.

45. The apparatus of claim 40, further including a rotational driver operationally connected to the mandrel to apply rotational movement to the mandrel and to the gripped tubular.

46. The apparatus of claim 43, further including a rotational driver operationally connected to the mandrel to apply rotational movement to the mandrel and to the gripped tubular.

47. The apparatus of claim 46, wherein the mandrel is disposed from a top drive.

48. The apparatus of claim 47, wherein the top drive is the rotational driver.

49. An apparatus for gripping and rotating a tubular, the apparatus comprising:
a mandrel having a longitudinal axis;
a floor providing a cam surface form on the mandrel, the floor having an angled taper relative to the longitudinal axis; and
a slip disposed on the floor, wherein axial movement of the slip urges the slip radially from the mandrel and wherein rotation of the mandrel urges the slip radially when the slip is in contact with a tubular.

50. A method for gripping a tubular, the method comprising the steps of:
disposing a slip on a mandrel;
disposing the slip adjacent to the tubular;
moving the slip axially and radially relative to the mandrel and into contact with the tubular; and
rotating the mandrel to urge the slip further radially into engagement with the tubular.
